(19) United States
(12) Patent Application Publication
(10) Pub. No.: US 2009/0198563 A1
(43) Pub. Date: Aug. 6, 2009

(54) METHOD FOR PRESENTING PROMOTIONAL INFORMATION ON A WEB PAGE

(76) Inventors: Chi-Chang Tung, Sindian City (TW); Chu-Hsien Hsu, Changhua City (TW)

Correspondence Address: LADAS & PARRY, 5670 WILSHIRE BOULEVARD, SUITE 2100, LOS ANGELES, CA, 90036-5679, US

(21) Appl. No.: 12/358,846

(22) Filed: Jan. 23, 2009

(30) Foreign Application Priority Data
Feb. 4, 2008 (TW) 097104201

(51) Int. Cl. G06Q 30/00

(52) U.S. Cl. 705/10; 705/26; 705/14

(57) ABSTRACT

A method for presenting supplemental promotional information on a web page includes: a) providing a shopping website that includes product web pages corresponding respectively to products; b) storing browsing activity information of a user with respect to the product web pages as a history log; c) analyzing the history log to calculate product interest parameters, each indicating interest of the user in a respective one of the products; d) storing the product interest parameters of the products; e) in response to intent of the user to browse one of the product web pages, retrieving the corresponding product interest parameter; and f) if the retrieved product interest parameter satisfies a condition, integrating supplemental promotional information giving details of the corresponding product into the browsed product web page.

### CROSS-REFERENCE TO RELATED APPLICATION

This application claims priority of Taiwanese Application No. 097104201, filed on Feb. 4, 2008.

### BACKGROUND OF THE INVENTION

1. Field of the Invention

The invention relates to a method for presenting promotional information on a web page, in which the promotional information is presented in response to past activity of a user and is related to content on the web page.

2. Description of the Related Art

Promotional activities on the Internet are becoming increasingly targeted. That is, rather than targeting a broadly-defined demographic, as in the case of traditional marketing, Internet marketing aims to reach out to an audience and even individuals with a specific behavior or interest. In order to benefit both users and vendors, more sophisticated and improved methods are needed to better target individuals with highly effective advertising and other promotional activities on the Internet.

### SUMMARY OF THE INVENTION

Therefore, the object of the present invention is to provide a method for presenting promotional information on a web page, in which the promotional information is presented in response to past activity of a user and is related to content on a browsed web page.

According to a first aspect of this invention, the method for presenting supplemental promotional information on a web page comprises: a) providing a shopping website that includes a plurality of product web pages corresponding respectively to a plurality of products; b) storing browsing activity information of a user with respect to the product web pages as a history log; c) analyzing the history log to thereby calculate product interest parameters, each indicating interest of the user in a respective one of the products; d) storing the product interest parameters of the products; e) in response to intent of the user to browse one of the product web pages, retrieving the product interest parameter for the product corresponding to said one of the product web pages; and f) if the product interest parameter retrieved in step e) satisfies a predetermined condition, integrating supplemental promotional information into said one of the product web pages, the supplemental promotional information giving details of the product corresponding to said one of the product web pages.

According to a second aspect of this invention, the method for presenting supplemental promotional information on a web page comprises: a) providing a shopping website that is managed by a vendor and that includes a plurality of product web pages corresponding respectively to a plurality of products; b) storing browsing activity information of a user with respect to the product web pages as a history log; c) analyzing the history log to thereby calculate product interest parameters, each indicating interest of the user in a respective one of the products; d) storing the product interest parameters of the products; e) in response to intent of the user to browse one of the product web pages, retrieving the product interest parameter for the product corresponding to said one of the product web pages; and f) if the product interest parameter retrieved in step e) satisfies a predetermined condition, integrating supplemental promotional information into said one of the product web pages, the supplemental promotional information giving details of a product that is related to but different from the product corresponding to said one of the product web pages, the relation of the supplemental promotional information to the product corresponding to said one of the product web pages being predetermined by the vendor managing the shopping website.

According to a third aspect of this invention, the method for presenting supplemental promotional information on a web page comprises: a) providing a shopping website that includes a plurality of product web pages corresponding respectively to a plurality of products; and b) in response to intent of the user to browse one of the product web pages, randomly selecting supplemental promotional information related to the product corresponding to said one of the product web pages from among a plurality of supplemental promotional information, and integrating the selected supplemental promotional information into said one of the product web pages.

According to a fourth aspect of this invention, the method for presenting associated information comprises: a) providing a browsable medium which includes a plurality of pieces of information content corresponding respectively to a plurality of topics; b) recording browsing activity information of a user with respect to the pieces of information content; c) analyzing the browsing activity information so as to determine and record a frequency at which the user browses each of the pieces of information content; d) in response to intent of the user to browse one of the pieces of information content, retrieving the frequency of the user browsing said one piece of information content; and e) if the frequency retrieved in step d) satisfies a predetermined condition, integrating associated information into said one piece of information content, the associated information being related to the topic corresponding to said one piece of information content.

According to a fifth aspect of this invention, the method for presenting promotional information on a results page of a search engine comprises: a) recording search query activity of a user; b) analyzing the search query activity so as to determine and record frequencies at which the user enters key words; c) in response to the user entering a search query into the search engine using a key word, retrieving the frequency of the user entering the key word; and d) if the frequency retrieved in step c) satisfies a predetermined condition, integrating promotional information into a results page returned by the search engine in response to the search query, the promotional information being related to the key word.

### BRIEF DESCRIPTION OF THE DRAWINGS

Other features and advantages of the present invention will become apparent in the following detailed description of the preferred embodiments with reference to the accompanying drawings, of which:

FIG. 1 is a flowchart of a method for presenting promotional information on a web page according to a first preferred embodiment of the present invention;

FIG. 2 is a schematic diagram of an exemplary web page that is included in a shopping website provided by the method of the first preferred embodiment;

FIG. 3 is a flowchart of additional steps that may be included in the method of the first preferred embodiment;

FIG. 4 is a flowchart of a method for presenting promotional information on a web page according to a second preferred embodiment of the present invention;

FIG. 5 is a flowchart of a method for presenting promotional information on a web page according to a third preferred embodiment of the present invention;

FIG. 6 is a flowchart of a method according to a fourth preferred embodiment of the present invention; and

FIG. 7 is a schematic diagram of a system for presenting promotional information on a web page according to a preferred embodiment of the present invention.

### DETAILED DESCRIPTION OF THE PREFERRED EMBODIMENTS

A method for presenting promotional information on a web page according to a first preferred embodiment of the present invention is implemented in an online shopping setting. Since a web page associated with online shopping typically already includes promotional information, the promotional information presented by the method of the first preferred embodiment will herein after be referred to as “supplemental promotional information.” The method of the first preferred embodiment may be performed by a server which runs an online shopping application.

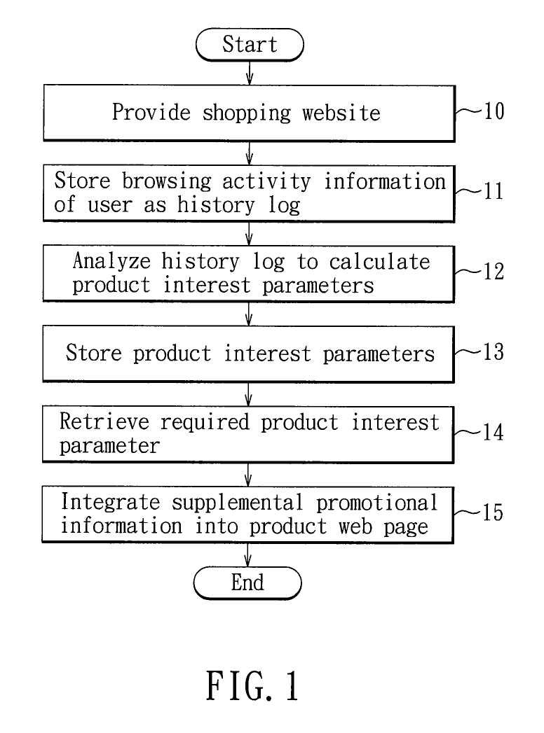

The method for presenting supplemental promotional information on a web page according to the first preferred embodiment of the present invention will now be described with reference to FIG. 1.

First, in step 10, a shopping website is provided that includes a plurality of product web pages corresponding respectively to a plurality of products.

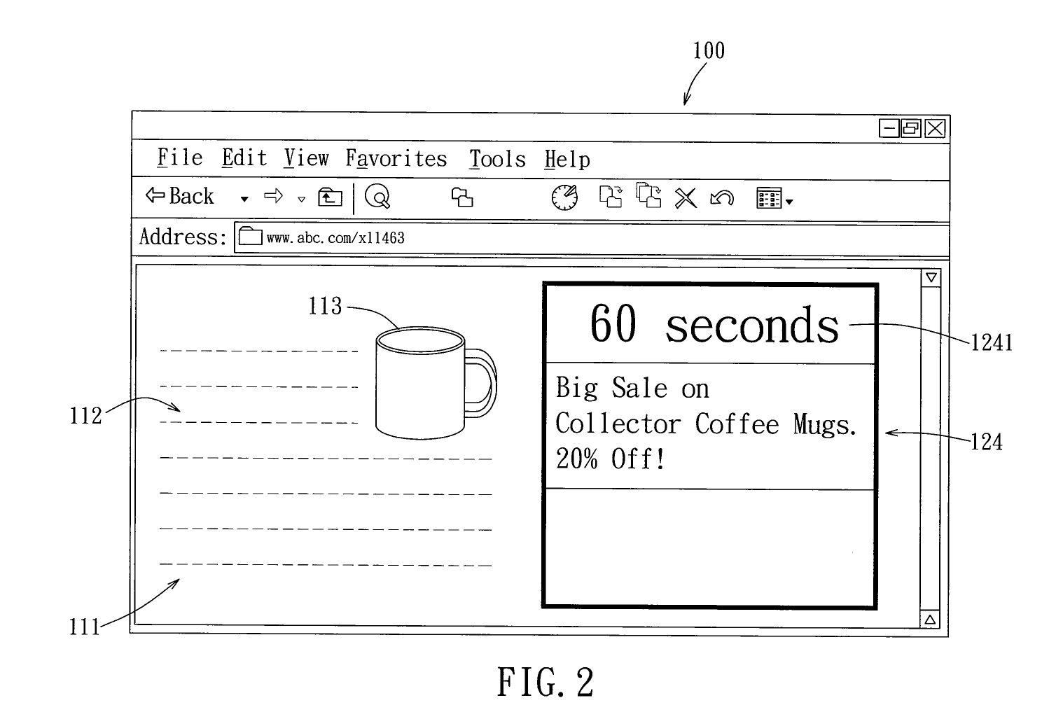

In the first preferred embodiment, the product web pages are written in HTML (HyperText Markup Language). FIG. 2 shows an example of a product web page 111 that is displayed by a web browser 100 and that is included in the shopping website provided in step 10. The product web page 111 displays a picture 113 of a product corresponding to the product web page 111, and provides a description 112 of the product.

In this and the other embodiments, “product” may refer to the following: a tangible product, such as that represented by the picture 113 in FIG. 2; an intangible product, such as a subscription to a website or a code or voucher number used in future purchases of products or services; or to a ticket or coupon, such as a gift certificate, an airline ticket, a discount coupon, an entertainment ticket, etc.

Next, in step 11, browsing activity information of a user with respect to the product web pages is stored as a history log.

The browsing activity information of the user may be obtained in a variety of ways. In one embodiment, the user establishes an account with the shopping website. Subsequently, when the user logs in to his or her account, the server is able to track the browsing activity of the user. In another embodiment, HTTP (Hypertext Transfer Protocol) cookies may be sent by the server to the web browser 100 of the user to track the browsing activity of the user. In yet another embodiment, the server identifies the user through an IP (Internet Protocol) address assigned to the user's computer. As an example, the IP address may be used by the server if the user has disabled cookies in his or her web browser 100. However, the present invention is not limited to the manner in which browsing activity information of the user is obtained, and other techniques may be employed to track user browsing activity.

Subsequently, in step 12, the history log is analyzed to thereby calculate product interest parameters, each indicating interest of the user in a respective one of the products.

Product interest parameters may be calculated in many ways, and the particular technique used may be decided upon by a vendor managing the shopping website provided in step 10. As an example, a technique may be used that involves comparing the total number of times the user has visited the shopping website with the number of times the user has browsed each of the product web pages, such as the product web page 111 shown in FIG. 2. A ratio may be obtained through such a comparison, and this ratio may be used as an indication of the product interest in one of the products. However, the present invention is not limited in this regard, and appreciably more sophisticated probabilistic techniques may be employed to determine each of the product interest parameters. For example, in order to determine the product interest parameter for any particular product, a probabilistic technique may be used which factors a large number of variables into the calculations, such as the sales price of the product, the geographic location of the user, the current popularity of the product, etc.

Next, in step 13, the product interest parameters of the products are stored.

In step 14, in response to intent of the user to browse one of the product web pages, the product interest parameter for the product corresponding to said one of the product web pages is retrieved. For the remainder of the description of the first and second preferred embodiments, it will be assumed that the “one of the product web pages” that the user intends to browse is the product web page 111 shown in FIG. 2. It is to be noted that in some embodiments, the product interest parameters may be periodically retrieved, e.g., every five minutes, so that the product interest parameters are immediately available.

Finally, in step 15, if the product interest parameter retrieved in step 14 satisfies a predetermined condition, supplemental promotional information is integrated into the product web page 111.

In one embodiment, the retrieved product interest parameter satisfies the predetermined condition when the retrieved product interest parameter is not less than a predetermined threshold value. For example, the ratio obtained by comparing the total number of times the user has visited the shopping website and the number of times the user has browsed the product web page 111 may be compared to a predetermined threshold ratio, and if the obtained ratio is greater than or equal to the predetermined threshold ratio, the supplemental promotional information may be integrated into the product web page 111.

In the first preferred embodiment, the supplemental promotional information gives details of the product corresponding to the product web page 111. FIG. 2 shows an example of supplemental promotional information 124. In the example shown in FIG. 2, the supplemental promotional information 124 states, “Big Sale on Collector Coffee Mugs. 20% Off!”

In other embodiments, the supplemental promotional information gives details of a product that is related to but different from the product corresponding to the product web page 111. In such embodiments, the relation of the supplemental promotional information to the product corresponding to the product web page 111 is predetermined by the vendor managing the shopping website. For example, if the product corresponding to the product web page 111 is a cell phone manufactured by company X, the supplemental promotional information may provide details of a cell phone manufactured by company Y having features similar to the cell phone manufactured by company X. As another example, if the product corresponding to the product web page 111 is an optical mouse, the supplemental promotional information may give details of a keyboard. Therefore, in FIG. 2, the supplemental promotional information 124 may instead read, “Big Sale on Crystal Wine Glasses. 30% Off!”

Hence, when the supplemental promotional information gives details of a product that is related to but different from the product corresponding to the product web page 111, the sale amount may be larger than when the supplemental promotional information 124 is directly related to the product corresponding to the product web page 111 to make the promotion more enticing.

In some embodiments, the supplemental promotional information gives details of more than one product, in which the details of one product may be directly related to the product corresponding to the product web page 111 and the details of the other product(s) may be related to but different from the product corresponding to the product web page 111, or the details of all the products may be related to but different from the product corresponding to the product web page 111.

Integration of the supplemental promotional information 124 into the product web page 111 of step 15 may be performed using, for example, any one of the two following techniques, the sequential steps for which are described as they would be performed by the server.

1) The server detects a request by the user to browse the product web page 111. In response, the server retrieves the product interest parameter for the product corresponding to the product web page 111 in step 14, and in step 15, if the retrieved product interest parameter satisfies the predetermined condition, integrates the supplemental promotional information 124 into the product web page 111. Finally, the server responds to the user's request and transmits the product web page 111 with the supplemental promotional information 124 integrated therein to the user.

2) The server detects a request by the user to browse the product web page 111. In response, the server embeds a plug-in object and a magic number into the product web page 111 and then transmits the product web page 111 to the user. When the web browser of the user receives the product webpage 111, the plug-in object is activated to send the magic number to the server. After receiving the magic number, the server determines the identity of the user through the magic number, retrieves the product interest parameter for the product corresponding to the product web page 111 in step 14, and in step 15, if the retrieved product interest parameter satisfies the predetermined condition, transmits the supplemental promotional information 124 to the plug-in object to effect integration of the supplemental promotional information 124 into the product web page 111.

Each of the above techniques has an advantage and a disadvantage. In the case of the first technique in which the server integrates the supplemental promotional information 124 before transmitting the product web page 111 to the user, the user may experience an overall slow browsing experience when network traffic is heavy and the server must therefore simultaneously integrate supplemental promotional information into many product web pages. With respect to the second technique involving transmission of the product web page 111 to the user prior to integration of the supplemental promotional information 124 thereinto, while the web page opens much quicker for the user in this case, the display speed for the supplemental promotional information 124 may be somewhat delayed. Hence, the vendor must consider these factors before deciding on the technique to use for integration of the supplemental promotional information.

In some embodiments, the supplemental promotional information may be integrated into the product web page 111 in the form of a hyperlink which the user can click on so as to be directed to a product purchasing web page associated with the supplemental promotional information 124.

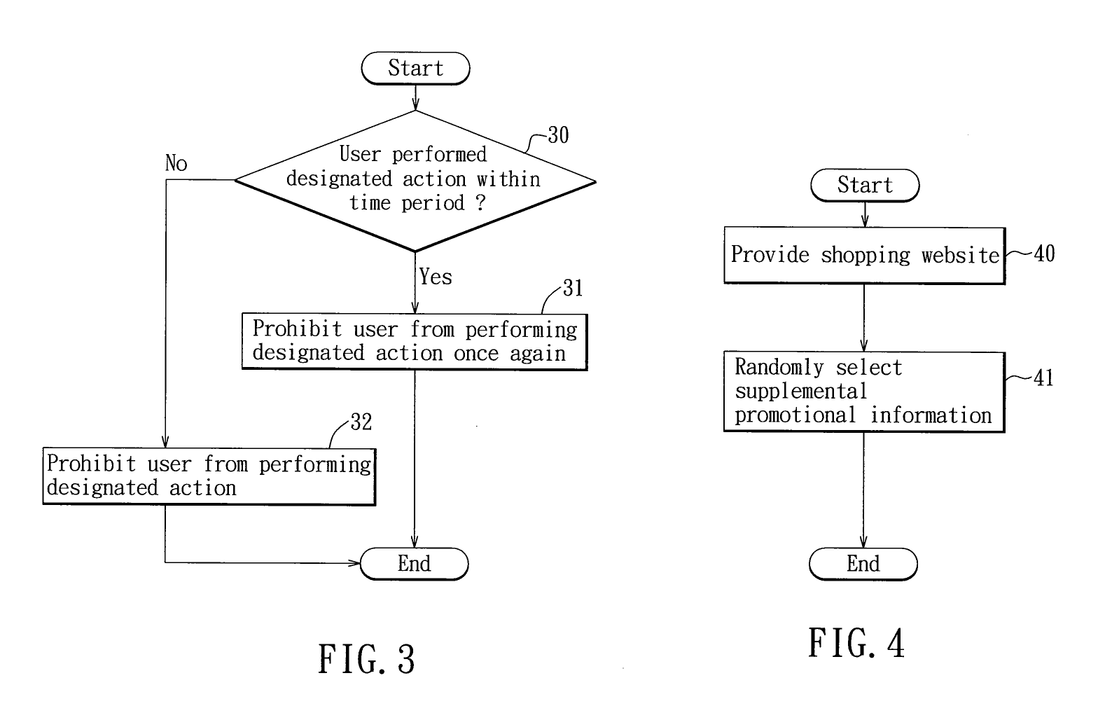

Referring to FIGS. 2 and 3, the method according to the first preferred embodiment of the present invention may include additional steps that function to motivate the user to click on the supplemental promotional information 124. In particular, a timer 1241 may be included in the supplemental promotional information 124, and the method of the present invention may include the additional steps as follows.

In step 30, detection is carried out to determine whether the user performs a designated action within a predetermined time period of integration of the supplemental promotional information 124 into the product web page 111. In the first preferred embodiment, the predetermined time period is indicated by the timer 1241. Further, in the first preferred embodiment, the designated action involves the user clicking on the supplemental promotional information 124, which is embedded in the product web page 111 as a hyperlink.

In step 31, if the user performs the designated action within the predetermined time period, the user is prohibited from performing the designated action once again in association with the supplemental promotional information 124. As an example, the supplemental promotional information 124 may be disabled so that the user can no longer click on the same.

In step 32, if the user does not perform the designated action within the predetermined time period, the user is prohibited from performing the designated action in association with the supplemental promotional information 124. As an example, the supplemental promotional information 124 may be either disabled or completely removed from the product web page 111.

As described above, control may be performed to link to a product purchasing web page (not shown) associated with the supplemental promotional information 124 if the user performs the designated action within the predetermined time period.

A method for presenting promotional information on a web page according to a second preferred embodiment of the present invention will now be described with reference to FIGS. 2 and 4. As in the case of the first preferred embodiment, the method according to the second preferred embodiment is implemented in an online shopping setting and therefore, the promotional information presented by the method of the second preferred embodiment will herein after be referred to as “supplemental promotional information.”

First, in step 40, a shopping website is provided that includes a plurality of product web pages corresponding respectively to a plurality of products.

Next, in step 41, in response to intent of the user to browse one of the product web pages (i.e., the product web page 111 of FIG. 2), supplemental promotional information (i.e., the supplemental promotional information 124 of FIG. 2) related to the product corresponding to the product web page 111 is randomly selected from among a plurality of supplemental promotional information, and the selected supplemental promotional information 124 is integrated into the product web page 111.

The advantage of the second preferred embodiment is that since the server does not need to calculate product interest parameters, a lesser processing burden is placed on the server, such that browsing speed and the speed at which supplemental promotional information is integrated into product web pages are increased.

As in the case of the first preferred embodiment, the method of the second preferred embodiment may include additional steps by associating a timer with the supplemental promotional information.

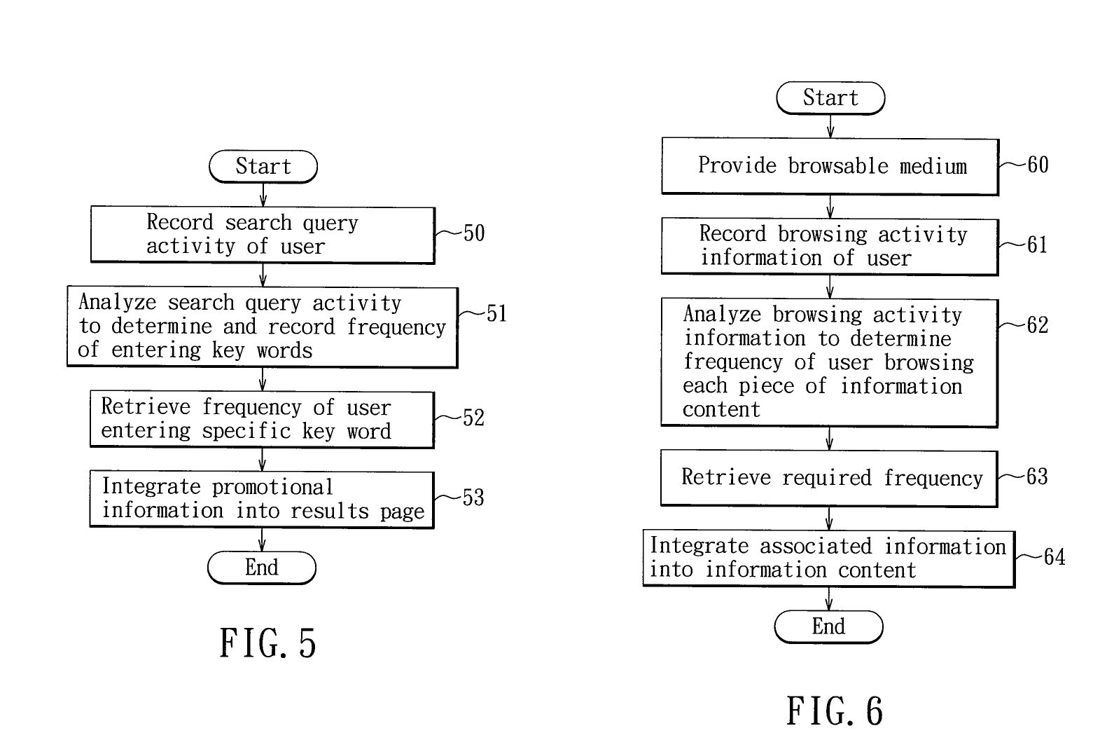

A method for presenting promotional information on a web page according to a third preferred embodiment of the present invention will now be described with reference to FIG. 5. The method of the third preferred embodiment is implemented in a search engine setting, and the promotional information is presented on a results page of a search engine. As an example, the method of the third preferred embodiment may be performed by a server which runs a search engine application.

First, in step 50, search query activity of a user is recorded.

Next, in step 51, the search query activity is analyzed so as to determine and record frequencies at which the user enters key words.

Subsequently, in step 52, in response to the user entering a search query into the search engine using a key word, the frequency of the user entering said key word is retrieved.

Finally, in step 53, if the frequency retrieved in step 52 satisfies a predetermined condition, promotional information is integrated into a results page returned by the search engine in response to the search query, in which the promotional information is related to the keyword. In one embodiment, the retrieved frequency satisfies the predetermined condition when the retrieved frequency is not less than a predetermined threshold value.

As in the case of the first preferred embodiment, the method of the third preferred embodiment may include additional steps by associating a timer with the promotional information.

In some embodiments, in step 52, in response to the user entering the search query into the search engine using a plurality of key words, the frequencies of the user respectively entering said keywords are retrieved, and in step 53, promotional information related to the key word associated with the highest frequency is integrated into the results page if the highest frequency satisfies the predetermined condition.

A method according to a fourth preferred embodiment of the present invention will now be described with reference to FIG. 6. The method of the fourth preferred embodiment may be implemented in an online dictionary setting, an online encyclopedia setting, a digital television video-on-demand service setting, etc.

First, in step 60, a browsable medium is provided which includes a plurality of pieces of information content corresponding respectively to a plurality of topics.

Next, in step 61, browsing activity information of a user with respect to the pieces of information content is recorded.

Subsequently, in step 62, the browsing activity information is analyzed so as to determine and record a frequency at which the user browses each of the pieces of information content.

Next, in step 63, in response to intent of the user to browse one of the pieces of information content, the frequency of the user browsing said one piece of information content is retrieved.

Finally, in step 64, if the frequency retrieved in step 63 satisfies a predetermined condition, associated information is integrated into said one piece of information content, in which the associated information is related to the topic corresponding to said one piece of information content. In one embodiment, in step 64, the frequency satisfies the predetermined condition when the frequency is not less than a predetermined threshold value.

As in the case of the first preferred embodiment, the method of the fourth preferred embodiment may include additional steps by associating a timer with the associated information.

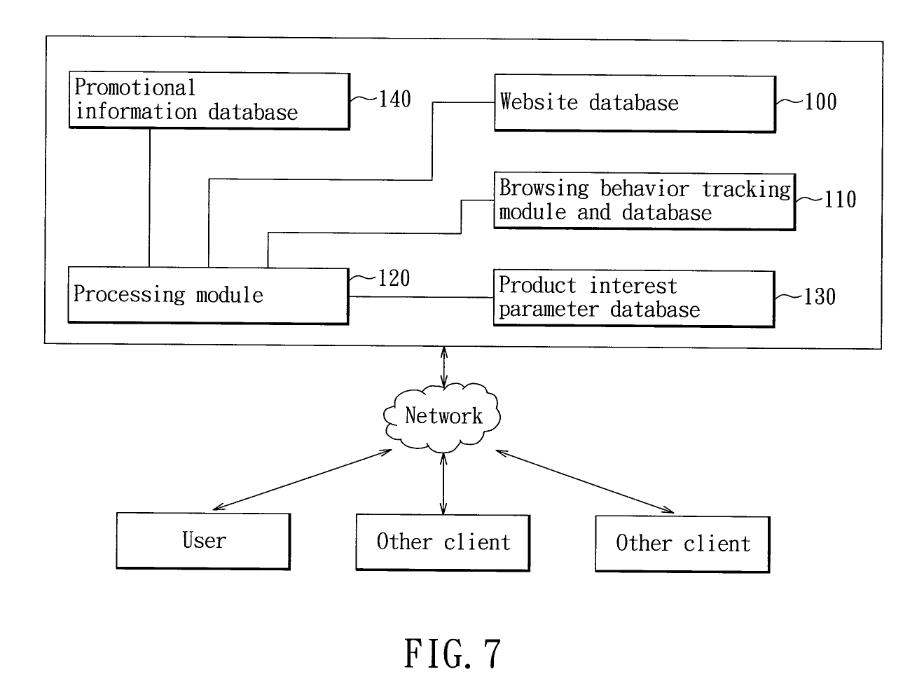

A system for presenting supplemental promotional information on a web page according to a preferred embodiment of the present invention will now be described with reference to FIG. 7. As an example, the system of the preferred embodiment is described as being configured to perform consecutive steps of the method of the first preferred embodiment. However, the present invention is not limited in this regard, and the system of the preferred embodiment may be configured to perform the consecutive steps of the method of any one of the preferred embodiments by making minor changes to the structure thereto (if needed).

The system for presenting supplemental promotional information on a web page according to the preferred embodiment of the present invention is included in a server which runs an online shopping application. It is to be noted that all of the elements of the system need not be included in the same server as shown in FIG. 7, and some of the elements of the system may be included in another server that is connected to and accessible by the server of FIG. 7 via a network.

The system for presenting supplemental promotional information on a web page according to the preferred embodiment of the present invention includes a website database 100, a browsing behavior tracking module and database 110, a processing module 120, a product interest parameter database 130, and a promotional information database 140.

The website database 100 has stored therein information of a shopping website that includes a plurality of product web pages corresponding respectively to a plurality of products.

The browsing behavior tracking module and database 110 tracks browsing activity of a user with respect to the product web pages, and stores corresponding browsing activity information of the user as a history log.

The processing module 120 is coupled to the website database 100, the browsing behavior tracking module and database 110, the product interest parameter database 130, and the promotional information database 140.

The processing module 120 analyzes the history log to thereby calculate product interest parameters, each indicating interest of the user in a respective one of the products. The processing module 120 further stores the product interest parameters of the products in the product interest parameter database 130.

In response to intent of the user to browse one of the product web pages, the processing module 120 retrieves the product interest parameter for the product corresponding to said one of the product web pages from the product interest parameter database 130.

If the product interest parameter retrieved from the product interest parameter database 130 satisfies a predetermined condition, the processing module 120 retrieves supplemental promotional information from the promotional information database 140, and integrates the supplemental promotional information into said one of the product web pages. In this embodiment, the supplemental promotional information gives details of the product corresponding to said one of the product web pages.

In the preferred embodiments of the present invention described above, promotional information is presented on a web page or associated information is integrated into information content in response to past activity of a user and in a manner related to content on the web page or to the topic corresponding to the information content. As a result, benefits are provided to both the user and the vendor.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for presenting supplemental promotional information on a web page, comprising:
a) providing a shopping website that includes a plurality of product web pages corresponding respectively to a plurality of products;
b) storing browsing activity information of a user with respect to the product web pages as a history log;
c) analyzing the history log to thereby calculate product interest parameters, each indicating interest of the user in a respective one of the products;
d) storing the product interest parameters of the products;
e) in response to intent of the user to browse one of the product web pages, retrieving the product interest parameter for the product corresponding to said one of the product web pages; and
f) if the product interest parameter retrieved in step e) satisfies a predetermined condition, integrating supplemental promotional information into said one of the product web pages, the supplemental promotional information giving details of the product corresponding to said one of the product web pages.

2. The method of claim 1, wherein, in step f), the retrieved product interest parameter satisfies the predetermined condition when the retrieved product interest parameter is not less than a predetermined threshold value.

3. The method of claim 1, further comprising:
g) detecting whether the user performs a designated action within a predetermined time period of integration of the supplemental promotional information into said one of the web pages;
h) if the user performs the designated action within the predetermined time period, prohibiting the user from performing the designated action once again in association with the supplemental promotional information; and
i) if the user does not perform the designated action within the predetermined time period, prohibiting the user from performing the designated action in association with the supplemental promotional information.

4. The method of claim 3, wherein if the user performs the designated action within the predetermined time period, control is performed to link to a product purchasing web page associated with the supplemental promotional information.

5. A method for presenting supplemental promotional information on a web page, comprising:
a) providing a shopping website that includes a plurality of product web pages corresponding respectively to a plurality of products;
b) storing browsing activity information of a user with respect to the product web pages as a history log;
c) analyzing the history log to thereby calculate product interest parameters, each indicating interest of the user in a respective one of the products;
d) storing the product interest parameters of the products;
e) in response to intent of the user to browse one of the product web pages, retrieving the product interest parameter for the product corresponding to said one of the product web pages; and
f) if the product interest parameter retrieved in step e) satisfies a predetermined condition, integrating supplemental promotional information into said one of the product web pages, the supplemental promotional information giving details of a product that is related to but different from the product corresponding to said one of the product web pages, the relation of the supplemental promotional information to the product corresponding to said one of the product web pages being predetermined by a website manager managing the shopping website.

6. The method of claim 5, wherein, in step f), the retrieved product interest parameter satisfies the predetermined condition when the retrieved product interest parameter is not less than a predetermined threshold value.

7. The method of claim 5, further comprising:
g) detecting whether the user performs a designated action within a predetermined time period of integration of the supplemental promotional information into said one of the web pages;
h) if the user performs the designated action within the predetermined time period, prohibiting the user from performing the designated action once again in association with the supplemental promotional information; and
i) if the user does not perform the designated action within the predetermined time period, prohibiting the user from performing the designated action in association with the supplemental promotional information.

8. The method of claim 7, wherein if the user performs the designated action within the predetermined time period, control is performed to link to a product purchasing web page associated with the supplemental promotional information.

9. A method for presenting supplemental promotional information on a web page, comprising:
a) providing a shopping website that includes a plurality of product web pages corresponding respectively to a plurality of products; and
b) in response to intent of the user to browse one of the product web pages, randomly selecting supplemental promotional information related to the product corresponding to said one of the product web pages from among a plurality of supplemental promotional information, and integrating the selected supplemental promotional information into said one of the product web pages.

10. The method of claim 9, further comprising:
c) detecting whether the user performs a designated action within a predetermined time period of integration of the supplemental promotional information into said one of the web pages;
d) if the user performs the designated action within the predetermined time period, prohibiting the user from performing the designated action once again in association with the supplemental promotional information; and
e) if the user does not perform the designated action within the predetermined time period, prohibiting the user from performing the designated action in association with the supplemental promotional information.

11. The method of claim 10, wherein if the user performs the designated action within the predetermined time period, control is performed to link to a product purchasing web page associated with the supplemental promotional information.

12. A method for presenting associated information, comprising:
a) providing a browsable medium which includes a plurality of pieces of information content corresponding respectively to a plurality of topics;
b) recording browsing activity information of a user with respect to the pieces of information content;
c) analyzing the browsing activity information so as to determine and record a frequency at which the user browses each of the pieces of information content;
d) in response to intent of the user to browse one of the pieces of information content, retrieving the frequency of the user browsing said one piece of information content; and
e) if the frequency retrieved in step d) satisfies a predetermined condition, integrating associated information into said one piece of information content, the associated information being related to the topic corresponding to said one piece of information content.

13. The method of claim 12, wherein, in step e), the frequency satisfies the predetermined condition when the frequency is not less than a predetermined threshold value.

14. The method of claim 12, further comprising:
f) detecting whether the user performs a designated action within a predetermined time period of integration of the associated information into said one piece of information content;
g) if the user performs the designated action within the predetermined time period, prohibiting the user from performing the designated action once again in association with the associated information; and
h) if the user does not perform the designated action within the predetermined time period, prohibiting the user from performing the designated action in association with the associated information.

15. A method for presenting promotional information on a results page of a search engine, comprising:
a) recording search query activity of a user;
b) analyzing the search query activity so as to determine and record frequencies at which the user enters key words;
c) in response to the user entering a search query into the search engine using a key word, retrieving the frequency of the user entering said key word; and
d) if the frequency retrieved in step c) satisfies a predetermined condition, integrating promotional information into a results page returned by the search engine in response to the search query, the promotional information being related to the key word.

16. The method of claim 15, wherein, in step d), the retrieved frequency satisfies the predetermined condition when the retrieved frequency is not less than a predetermined threshold value.

17. The method of claim 15, further comprising:
e) detecting whether the user performs a designated action within a predetermined time period of integration of the promotional information into the returned results page;
f) if the user performs the designated action within the predetermined time period, prohibiting the user from performing the designated action once again in association with the promotional information; and
g) if the user does not perform the designated action within the predetermined time period, prohibiting the user from performing the designated action in association with the promotional information.

18. The method of claim 17, wherein if the user performs the designated action within the predetermined time period, control is performed to link to a product purchasing web page associated with the promotional information.

19. The method of claim 15, wherein, in step c), in response to the user entering the search query into the search engine using a plurality of key words, the frequencies of the user respectively entering said key words are retrieved, and
in step d), promotional information related to the key word associated with the highest frequency is integrated into the results page if the highest frequency satisfies the predetermined condition.
